(19) United States
(12) Patent Application Publication
(10) Pub. No.: US 2023/0046635 A1
(43) Pub. Date: Feb. 16, 2023

(54) WATER-RESISTANT MULTILAYERED CELLULOSE-BASED SUBSTRATE

(71) Applicant: Stora Enso OYJ, Helsinki (FI)

(72) Inventors: Susanne Hansson, Tyresö (SE); Raija Bådenlid, Karlstad (SE)

(73) Assignee: Stora Enso OYJ, Helsinki (FI)

(21) Appl. No.: 17/760,129

(22) PCT Filed: Feb. 19, 2021
(86) PCT No.: PCT/IB2021/051417

§ 371 Date: Aug. 4, 2022

(30) Foreign Application Priority Data
Feb. 21, 2020 (SE) 2050194-6

(51) Int. Cl. D21H 27/32; D21H 21/16; D21H 19/58; D21H 19/60; D21H 19/38; D21H 17/18; D21H 17/11; B32B 5/02; B32B 5/26; B32B 5/10

(52) U.S. Cl. CPC D21H 27/32; B32B 5/02; B32B 5/10; B32B 5/26; D21H 17/11; D21H 17/18; D21H 19/58; D21H 19/60; D21H 19/385; D21H 21/16; B32B 2255/02; B32B 2255/20; B32B 2255/26; B32B 2307/718; B32B 2307/732

(57) ABSTRACT

The present invention relates to a multilayered cellulose-based substrate, comprising a cellulose-based first layer, and a cellulose-based second layer in contact with said first layer, wherein said substrate has a basis weight above 85 g/m², wherein said first layer comprises an internal sizing agent, and wherein said second layer has been subjected to grafting with a fatty acid halide through the entire thickness of said second layer. The invention further relates to a method for manufacturing the multilayered cellulose-based substrate.

### TECHNICAL FIELD

The present disclosure relates to cellulose-based substrates, such as paper or paperboard, for use in wet or damp environments.

### BACKGROUND

Water-resistance is an important property in many paper or paperboard applications. Some examples include packaging, such as boxes, and other containers; fresh and aseptic liquid packaging; boxes, trays, or cups for hot, cold, dry, wet and frozen food and beverages; products for outdoor use such as boxes, signs and posters; pots, trays and covers for plants; packages for construction materials, and construction materials.

Paper or paperboard for use in wet or damp environments are usually treated with sizing agents to enhance certain qualities; and above all, to increase the resistance to penetration of water and other liquids into the cellulose-based substrate, which is important to maintain the integrity and/or function of the substrate. There are two main types of sizing: internal sizing and surface sizing. For internal sizing, chemicals are added to the pulp at the wet end, for example alkyl ketene dimer (AKD), alkenyl succinic anhydride (ASA) or rosin sizing agent. Common surface-sizing agents include, e.g., modified starches, carboxymethyl cellulose, polyvinyl alcohol (PVOH) and acrylic co-polymers.

Coating of paper or paperboard with plastics is often employed to combine the mechanical properties of the paperboard with the barrier and sealing properties of a plastic film. Also in plastic coated paperboard, the board is often treated with a hydrophobic sizing agent to prevent so-called edge wick, i.e. absorption of liquid at the cut edges (or so-called raw edges) of the paperboard. Edge-wick resistance is an important parameter in many applications.

A problem with internal sizing agents, such as AKD, can be that they interfere with the hydrogen bonding between the cellulose fibers, giving a debonding effect and hence a weaker material. To compensate for the weaker material, the grammage of paper and board is increased leading to higher carbon footprint due to overuse of wood fibers and higher transport weight at all stages downstream the production.

Another problem associated with internal sizing agents is migration of the sizing chemicals which can result in deposits on the production machinery and/or finished products.

To improve the wet strength of the material, the internal sizing agent can be combined with a wet-strength agent. A wet-strength agent improves the tensile properties of the paper or paperboard in the wet state by for example covalently binding to the cellulose fibers and also by forming a crosslinked network between the fibers that does not break upon wetting. Common wet-strength agents include urea-formaldehyde (UF), melamine-formaldehyde (MF) and polyamide-epichlorohydrin (PAE). Other wet strength agents can give wet-strength by other mechanisms, and some of these wet-strength agents can also have a temporary wet-strength function.

A problem with the addition of wet strength agents is that the repulpability of the material is severely reduced.

Many paper and paperboard products are provided with a mineral-coated surface to give desirable properties such as whiteness, brightness, gloss, and/or high-quality print. Typical coating components include pigments, binders, additives, and water. Commonly used pigments include calcium carbonate, talc, titanium dioxide, and/or kaolin clay. As binder, a styrene/butadiene latex, styrene/acrylate latex, vinylacetate latex, vinylacetate/acrylate latex, carboxymethyl cellulose, starches, and/or polyvinyl alcohol can be utilized. A thickening agent to adjust the rheology can also be added, which also can work as a co-binder. Examples of other additives include insolubilizers, lubricants, defoamers, and optical brightening agents (OBAs).

As the mineral coating covers at least one of the surfaces of the paper or paperboard, it limits the accessibility of the cellulose-based surface to perform other surface-treatment procedures.

There remains a need for improved solutions to render cellulose-based substrates, such as paper or paperboard, water-resistant, without sizing agent migration issues, without weakening the material, and without losing the repulpability of the material. There also remains a need for improved solutions to reduce the need for plastics in paper and paperboard, which is beneficial both from a sustainability and recyclability perspective.

### DESCRIPTION OF THE INVENTION

It is an object of the present disclosure to provide a water-resistant cellulose-based substrate with good repulpability.

It is a further object of the present disclosure to provide a water-resistant cellulose-based substrate with improved wet strength and similar repulpability as compared to a corresponding non-water resistant cellulose-based substrate.

It is a further object of the present disclosure to provide a method for rendering a cellulose-based substrate water-resistant, without losing the repulpability of the material.

It is a further object of the present disclosure to provide a method for rendering a cellulose-based substrate water-resistant, which reduces the problem with sizing agent deposits on production machinery and/or finished products.

It is a further object of the present disclosure to provide a water-resistant cellulose-based substrate which is free from added wet strength agents, particularly crosslink-forming wet strength agents, for example urea-formaldehyde (UF), melamine-formaldehyde (MF) and/or polyamide-epichlorohydrin (PAE).

The above-mentioned objects, as well as other objects as will be realized by the skilled person in the light of the present disclosure, are achieved by the various aspects of the present disclosure.

According to a first aspect illustrated herein, there is provided a multilayered cellulose-based substrate, comprising
a cellulose-based first layer, and
a cellulose-based second layer in contact with said first layer,
wherein said substrate has a basis weight above 85 g/m²,
wherein said first layer comprises an internal sizing agent, and
wherein said second layer has been subjected to grafting with a fatty acid halide through the entire thickness of said second layer.

Grafting with fatty acid halide has been identified as an interesting alternative to internal sizing agents and wet-strength agents for rendering cellulose-based substrates hydrophobic. An advantage of grafting with fatty acid halides over internal sizing agents and wet-strength agents is the high reactivity of the fatty acid halides towards the hydroxyl groups present on the pulp fibers. The high reactivity of the fatty acid halides results in that the reagent will be covalently bound to the substrate to a much higher extent compared to internal sizing agents, reducing the issues related to migration. The fatty acid halide grafting is preferably performed on the formed and dried multilayered cellulose-based substrate. As the grafting is performed on the formed and dried substrate, the interference with fiber-fiber hydrogen bonding is very limited.

The present disclosure is based on the realization that a cellulose-based substrate having a basis weight above about 200 g/m², or in some cases even above about 150 g/m² or 85 g/m², cannot be efficiently subjected to grafting with a fatty acid halide at an industrial scale at high speed, such that grafting of fatty acids to the substrate material is achieved through the entire thickness of the substrate. This basis weight typically corresponds to a substrate thickness above 150 µm, depending on the density of the substrate. Thus, using grafting with a fatty acid halide as a method for rendering cellulose-based substrates hydrophobic at an industrial manufacturing scale is typically not feasible for thicker and/or mineral-coated substrates. This problem is also illustrated by Examples 1 and 2.

The present invention solves this problem by providing a multilayer substrate comprising at least two cellulose-based layers - a cellulose-based first layer and a cellulose-based second layer in contact with said first layer. The cellulose-based second layer is subjected to grafting with a fatty acid halide through the entire thickness of the layer. The cellulose-based first layer, which will not be subjected to grafting with a fatty acid halide through the entire thickness of the layer, is instead formed with an internal sizing agent to achieve full hydrophobicity throughout the entire substrate. In some embodiments, the grafting of the second layer will also extend partially into the first layer, such that the first layer is also being subjected to fatty acid halide grafting to a certain extent. In other words, a certain overlap of internal sizing agent and fatty acid halide grafting may occur at the interface between the first layer and the second layer. Migration of internal sizing agent from the first layer into the second layer may also result in a certain overlap of internal sizing agent and fatty acid halide grafting at the interface between the first layer and the second layer. A certain overlap of internal sizing agent and fatty acid halide grafting between the first layer and the second layer can be beneficial to ensure that no material remains unhydrophobized.

In one embodiment of the present invention said second layer comprises no internal sizing agent or a lower amount of internal sizing agent than said first layer. The grafting of fatty acid halides combined with the reduction of internal sizing agent compared to a similar substrate relying solely on an internal sizing agent for hydrophobicity reduces or completely eliminates the need for addition of a wet-strength agent. This allows for the cellulose-based substrate to be rendered water-resistant without losing the repulpability of the material.

The grafted cellulose-based second layer will also reduce the migration of internal sizing agent present in the first layer through the second layer to the surface of the substrate. This reduction of internal sizing agent migration will reduce the problems with sizing agent deposits on the production machinery and/or on finished products.

The cellulose-based substrate (also referred to herein as “the substrate”) is preferably a sheet or web of material mainly formed from pulp of wood or other fibrous substances comprising cellulose fibers. The substrate comprises at least two cellulose-based layers, a cellulose-based first layer, and a cellulose-based second layer in contact with said first layer. Each layer may in turn be comprised of two or more sublayers.

The cellulose-based substrate is preferably paperboard or high-grammage paper having a basis weight in the range of 85-500 g/m², and a density below 1000 kg/m³.

In some embodiments, the basis weight of the cellulose-based substrate is above 200 g/m². In some embodiments, the basis weight of the cellulose-based substrate is in the range of 200-400 g/m².

In some embodiments, the basis weight of the cellulose-based substrate is above 85 g/m². In some embodiments, the basis weight of the cellulose-based substrate is in the range of 85-300 g/m².

In some embodiments, the density of the cellulose-based substrate is below 800 kg/m³ or below 400 kg/m³.

The thickness of the multilayered substrate is preferably above 200 µm, such as in the range of 200-1000 µm.

Paper generally refers to a material manufactured in sheets or rolls from the pulp of wood or other fibrous substances comprising cellulose fibers, used for e.g. writing, drawing, or printing on, or as packaging material. Paper used in the present disclosure is high-grammage paper, such as liner, having a basis weight in the range of 85 - 300 g/m², or in the range of 85 - 200 g/m². High-grammage paper such as liner can either be bleached or unbleached, coated or uncoated, and produced in a variety of thicknesses, depending on the end-use requirements. Also, high-grammage paper can comprise more than two layers, such as three or more layers.

Paperboard generally refers to strong, thick paper or cardboard comprising cellulose fibers used for example as flat substrates, trays, boxes and/or other types of packaging. Paperboard can either be bleached or unbleached, coated or uncoated, and produced in a variety of thicknesses, depending on the end-use requirements.

The multilayered cellulose-based substrate is preferably water-resistant. The term “water-resistant” generally means that the multilayered cellulose-based substrate with the internal sizing agent and grafted fatty acid halide has a higher resistance to water absorption (e.g. indicated by the Cobb₆₀ value as determined according to standard ISO 535:2014 after 60 seconds) and better edge-wick resistance (e.g. determined using lactic acid 1 % solution, 1 h at 23° C. and 50 % relative humidity) than the same multilayered cellulose-based substrate without said internal sizing agent and grafted fatty acid halide.

The cellulose-based substrate is preferably for suitable use in wet or damp environments. In some embodiments, the cellulose-based substrate is for use in packaging, such as boxes, and other containers; fresh and aseptic liquid packaging; boxes, trays, or cups for hot, cold, dry, wet and frozen food and beverages; products for outdoor use such as boxes, signs and posters; pots, trays and covers for plants; packages for construction materials, and construction materials.

The cellulose-based second layer should preferably be capable of being grafted with fatty acids through the entire thickness of the second layer. Thus, in some embodiments the second layer has a basis weight below 150 g/m², preferably below 100 g/m² or below 50 g/m². The second layer preferably has a basis weight above 20 g/m².

In some embodiments, the second layer has a thickness below 200 µm, preferably below 150 µm or below 100 µm. The second layer preferably has a thickness above 30 µm.

In an illustrative example, the substrate has a basis weight of 175 g/m² (i.e. above 150 g/m²), the second layer has a basis weight of 75 g/m²(i.e. below 100 g/m²), and consequently the first layer has a basis weight of 100 g/m2.

In another illustrative example, the substrate has a basis weight of 400 g/m² (i.e. above 150 g/m²), the second layer has a basis weight of 100 g/m² (i.e. below 150 g/m²), and consequently the first layer has a basis weight of 300 g/m².

In another illustrative example, the substrate is a liner comprising at least two layers, said liner having a basis weight of 85-200 g/m² and a thickness above 100 pm.

According to one aspect, in order to minimize the amount of internal sizing agent in the substrate and prevent sizing agent migration and deposits, the second layer comprises no internal sizing agent or a lower amount of internal sizing agent than said first layer. In some embodiments, the second layer comprises no internal sizing agent.

In some embodiments, the multilayered cellulose-based substrate further comprises
a cellulose-based third layer in contact with said first layer,
wherein said substrate has a basis weight above 85 g/m²,
wherein said third layer has been subjected to grafting with a fatty acid halide through the entire thickness of said third layer.

In some embodiments, the substrate has a basis weight above 150 g/m², or above 200 g/m².

The cellulose-based third layer is preferably in contact with the first layer such that the first layer is sandwiched between the second layer and the third layer.

According to one aspect, said third layer comprises no internal sizing agent or a lower amount of internal sizing agent than said first layer. The grafted cellulose-based third layer will thus further reduce the migration of internal sizing agent present in the first layer to the surfaces of the substrate. This reduction of internal sizing agent migration will further reduce the problems with sizing agent deposits on the production machinery and/or in finished products.

In other words, in some embodiments the multilayered cellulose-based substrate further comprises a cellulose-based third layer, preferably similar to the second layer, in contact with said first layer such that the first layer is sandwiched between the second layer and the third layer.

As described above with reference to the second layer, the grafting of the third layer may also extend partially into the first layer, such that the first layer is also being subjected to fatty acid halide grafting to a certain extent. Migration of internal sizing agent from the first layer into the third layer may also result in a certain overlap of internal sizing agent and fatty acid halide grafting at the interface between the first layer and the third layer. A certain overlap of internal sizing agent and fatty acid halide grafting between the first layer and the third layer can be beneficial to ensure that no material remains unhydrophobized.

The cellulose-based third layer should preferably be capable of being grafted with fatty acids through the entire thickness of the third layer. Thus, in some embodiments the third layer has a basis weight below 150 g/m², preferably below 100 g/m² or below 50 g/m². The third layer preferably has a basis weight above 20 g/m2.

In some embodiments, the third layer has a thickness below 200 µm,preferably below 150 µm or below 50 µm. The third layer preferably has a thickness above 30 µm.

In an illustrative example, the substrate has a basis weight of 300 g/m² (i.e. above 200 g/m²), the second layer has a basis weight of 50 g/m² (i.e. below 100 g/m²), the third layer has a basis weight of 50 g/m² (i.e. below 100 g/m²), and consequently the first layer has a basis weight of 200 g/m².

In another illustrative example, the substrate has a basis weight of 400 g/m²
(i.e. above 200 g/m²), the second layer has a basis weight of 100 g/m²
(i.e. below 150 g/m²), the third layer has a basis weight of 100 g/m²
(i.e. below 150 g/m²), and consequently the first layer has a basis weight of 200 g/m2.

The basis weight of the second and third layer can be the same or different.

In some embodiments, the third layer comprises no internal sizing agent.

Coated substrates, especially substrates coated with polymer or mineral coating, make it difficult to use grafting with a fatty acid halide as a method for rendering cellulose-based substrates hydrophobic since the coating reduces or entirely prevents diffusion of the fatty acid halide into the underlying cellulose-based layer. Therefore, the present invention is especially advantageous for multilayered cellulose-based substrates where one side of the first cellulose based layer is provided with a coating layer.

In some embodiments, the multilayered cellulose-based substrate further comprises
a coating layer in contact with said first layer,
wherein said substrate has a basis weight above 85 g/m²

The coating layer is preferably in contact with the first layer such that the first layer is sandwiched between the second layer and the coating layer.

In other words, in alternative embodiments the multilayered cellulose-based substrate comprises a coating layer in contact with said first layer such that the first layer is sandwiched between the second layer and the coating layer.

In some embodiments, the coating layer is a polymer or mineral coating layer.

In some embodiments, the coating layer is a mineral coating layer. The mineral coating may comprise pigments, binders, and additives. Commonly used pigments include calcium carbonate, talc, titanium dioxide, and/or kaolin clay. As binder, a styrene/butadiene latex, styrene/acrylate latex, vinylacetate latex, vinylacetate/acrylate latex, carboxymethyl cellulose, starches, and/or polyvinyl alcohol can be utilized. A thickening agent to adjust the rheology can also be added, which also can work as a co-binder. Examples of other additives include insolubilizers, lubricants, defoamers, and optical brightening agents (OBAs).

In some embodiments the coating layer is a polyvinyl alcohol (PVOH) coating layer. The PVOH of the PVOH coating layer may be a single type of PVOH, or it can comprise a mixture of two or more types of PVOH, differing in for example degree of hydrolysis or viscosity. The PVOH may for example have a degree of hydrolysis in the range of 80-99 mol%, preferably in the range of 88-99 mol%. Furthermore, the PVOH may preferably have a viscosity above 5 mPa×s in a 4 % aqueous solution at 20° C. DIN 53015/ JIS K 6726. The PVOH coating layer may optionally be subjected to grafting with a fatty acid halide. Grafting of PVOH with a fatty acid halide is described for example in the international patent application WO2009083525A1 .

In some embodiments, the coating layer has a basis weight in the range of 1-50 g/m², or more preferably 4-30 g/m².

In an illustrative example, the substrate has a basis weight of 175 g/m²
(i.e. above 150 g/m²), the second layer has a basis weight of 60 g/m²
(i.e. below 100 g/m²), the coating layer has a basis weight of 15 g/m², and consequently the first layer has a basis weight of 100 g/m².

In another illustrative example, the substrate has a basis weight of 400 g/m²
(i.e. above 150 g/m²), the second layer has a basis weight of 150 g/m²
(i.e. below 150 g/m²), the coating layer has a basis weight of 20 g/m², and consequently the first layer has a basis weight of 230 g/m².

Each of the cellulose-based layers of the cellulose-based substrate may be comprised of a single pulp layer or comprised of two or more sublayers. Each layer or sublayer can have a certain composition of pulp fibers, such as bleached and/or unbleached Kraft pulp, sulfite pulp, dissolving pulp, thermomechanical pulp (TMP), chemi-thermomechanical pulp (CTMP), high-temperature CTMP (HT-CTMP) and/or mixtures thereof.

As an example, the substrate can be built up of one top layer (second layer) consisting of bleached Kraft pulp, a mid layer (first layer) consisting of a mixture of bleached Kraft pulp and CTMP, and a bottom layer (third layer) consisting of bleached Kraft pulp, wherein the mid layer (first layer) has a higher thickness than both the top and bottom layers, respectively.

In some embodiments, the cellulose-based first layer, the cellulose-based second layer and/or the cellulose-based third layer is comprised of two or more cellulose-based sublayers. The cellulose-based first layer, the cellulose-based second layer and/or the cellulose-based third layer may for example be comprised of two to four cellulose-based sublayers. The different sublayers can have different grammages and/or thicknesses and may contain different amounts of internal sizing agent and/or grafted fatty acids.

Internal sizing agents are often used in paper or paperboard for use in wet or damp environments. Internal sizing agents are added to the pulp at the wet end, i.e. in the wet pulp mixture. The most common internal sizing agents are alkyl ketene dimer (AKD), alkenyl succinic anhydride (ASA) and rosin sizing agents. However, other agents that increase the resistance to penetration of water and other liquids into the cellulose-based substrate may also be used as internal sizing agents. Examples include fatty acids, fatty acid derivatives, and/or combinations thereof. Thus, in some embodiments of the multilayered cellulose-based substrate, the internal sizing agent is a hydrophobic internal sizing agent, preferably a hydrophobic internal sizing agent selected from the group consisting of alkyl ketene dimer (AKD), alkenyl succinic anhydride (ASA), a rosin sizing agent, a fatty acid, a fatty acid derivative, and combinations thereof. In some embodiments of the multilayered cellulose-based substrate, the internal sizing agent is selected from the group consisting of alkyl ketene dimer (AKD), alkenyl succinic anhydride (ASA), a rosin sizing agent, and combinations thereof.

The amount of internal sizing agent in the first layer of the multilayered cellulose-based substrate is preferably sufficient to render the first layer hydrophobic. In some embodiments, the first layer of the multilayered cellulose-based substrate comprises an amount of internal sizing agent in the range of 0.1-5 kg internal sizing agent per ton of dry substrate.

The fatty acid halide grafting through the entire thickness of the cellulose-based layers removes the need for a hydrophobic sizing agent in the grafted layers. Thus, in preferred embodiments the grafted layers of the substrate are free from added hydrophobic sizing agents, for example alkyl ketene dimer (AKD), alkenyl succinic anhydride (ASA) and/or rosin-sizing agent.

According to one aspect of the invention, the amount of internal sizing agent in the substrate is reduced by means of combining a sized layer (the first layer) with non-sized layer/s or layer/s with reduced sizing (the second and third layers). The reduction of internal sizing agent compared to a similar substrate relying solely on an internal sizing agent for hydrophobicity can reduce or completely eliminate the need for addition of a wet strength agent, for example polyamide-epichlorohydrin (PAE). This allows for the cellulose-based substrate to be rendered water-resistant, without losing the repulpability of the material.

Thus, in some embodiments, the multilayered cellulose-based substrate comprises no added wet-strength agent.

In some embodiments, the fatty acid halide grafted on the cellulose-based substrate has an aliphatic chain length of 8-22 carbon atoms. Examples of fatty acid halides include octanoyl chloride (C8), lauroyl chloride (C12), myristoyl chloride (C14), palmitoyl chloride (C16), and stearoyl chloride (C18), and/or a mixture thereof. In some preferred embodiments, the fatty acid halide grafted on the cellulose-based substrate is palmitoyl chloride or stearoyl chloride or mixtures thereof.

Grafting of the fatty acid halide to the cellulose-based substrate having available hydroxyl groups can be achieved by applying a fatty acid halide to the surface of the substrate, followed by penetration of the reagent upon heating, which also promotes the formation of covalent bonds between the fatty acid halide and the hydroxyl groups of the substrate. The grafting typically involves contacting the substrate with a fatty acid halide in a liquid, spray and/or vapor state. The reaction between the fatty acid halide, e.g. fatty acid chloride, and the hydroxyl groups of the substrate results in ester bonds between the reagent and the substrate. Ungrafted and thereby unbound fatty acids may also be present to a certain extent. Upon the reaction with the hydroxyl groups in the substrate, and/or with water in the substrate and/or in the air, hydrohalic acid, e.g. hydrochloric acid, is formed as a reaction byproduct. The grafting may preferably be followed by removal of the formed hydrohalic acid, and optionally by removal of the ungrafted residues. One example of a grafting process which could be used in production of the water-resistant cellulose-based substrate of the present disclosure is described in detail in the international patent application WO2012066015A1. Another example of a grafting process, which could be used in production of the water-resistant cellulose-based substrate in the present disclosure, is described in detail in the international patent application WO2017002005A1. The grafting process may also be repeated, in order to increase the amount of grafted and free fatty acids in the cellulose-based substrate.

The cellulose-based substrate is preferably dry when the fatty acid halide grafting is performed. The term “dry” as used herein means that the cellulose-based substrate has a dry content above 80 %, preferably above 85 %, and more preferably above 90 % by weight.

The fatty acid halide grafting preferably results in a total amount of grafted and free fatty acids in the cellulose-based substrate in the range of 0.05-5 kg/ton of the total dry weight of the substrate.

In some embodiments, a surface of said substrate subjected to grafting with a fatty acid halide has a water contact angle above 90°, preferably above 100°.

The fatty acid halide grafting results in a cellulose-based substrate having a Cobb₆₀ value below 30 g/m² In some embodiments, a surface of said substrate subjected to grafting with a fatty acid halide has a Cobb₆₀ value (as determined according to standard ISO 535:2014 after 60 seconds) below 30 g/m², preferably below 20 g/m², more preferably below 15 g/m².

In some embodiments, the substrate has an edge wick index (Lactic acid 1% solution, 1 h at 23° C. and 50 % relative humidity) below 1.5 kg/m²h, preferably below 1 kg/m²h, and even more preferably below 0.5 kg/m²h.

In some embodiments, the substrate has an edge wick index (hydrogen peroxide 35 % solution, 10 min at 70° C.) below 5 kg/m²h, preferably below 2.5 kg/m²h, and even more preferably below 2 kg/m²h.

In some embodiments, the substrate has an edge wick index (warm water, 90 min at 55° C.) below 5 kg/m²h, preferably below 2.5 kg/m²h, and even more preferably below 2 kg/m²h.

In some embodiments, the cellulose-based substrate subjected to grafting with a fatty acid halide has a repulpability characterized by a reject rate (as determined according to the PTS RH 021/97 test method) below 20%, preferably below 10%, and more preferably below 5%.

According to a second aspect illustrated herein, there is provided a method for manufacturing a multilayered cellulose-based substrate, said method comprising:
a) forming a multilayered cellulose-based substrate comprising
   a cellulose-based first layer, and
   a cellulose-based second layer in contact with said first layer,
   wherein said first layer is formed of a first pulp mixture comprising a concentration of an internal sizing agent, and
   b) subjecting said second layer of the formed multilayered cellulose-based substrate to grafting with a fatty acid halide through the entire thickness of said second layer.

The cellulose-based substrate is preferably paperboard or high-grammage paper having a basis weight in the range of 85-500 g/m², and a density below 1000 kg/m³.

In some embodiments, the basis weight of the cellulose-based substrate is above 150 g/m², preferably above 200 g/m². In some embodiments, the basis weight of the cellulose-based substrate is in the range of 200-400 g/m².

In some embodiments, the density of the cellulose-based substrate is below 800 kg/m³ or below 400 kg/m³.

The thickness of the multilayered substrate is preferably above 100 µm, such as in the range of 100-1000 µm.

The cellulose-based second layer should preferably be capable of being grafted with fatty acid halides through the entire thickness of the second layer. Thus, in some embodiments the second layer has a basis weight below 150 g/m², preferably below 100 g/m² or below 50 g/m². The second layer preferably has a basis weight above 20 g/m².

In some embodiments, second layer has a thickness below 200 µm, preferably below 150 µm or below 100 µm. The second layer preferably has a thickness above 30 µm.

In one aspect of the method, the second layer comprises no internal sizing agent or a lower amount of internal sizing agent than said first layer in order to minimize the amount of internal sizing agent in the substrate. In some embodiments, the second layer comprises no internal sizing agent.

In some embodiments, the multilayered cellulose-based substrate further comprises a cellulose-based third layer in contact with said first layer. Thus, in some embodiments, the method comprises:
a) forming a multilayered cellulose-based substrate comprising
   a cellulose-based first layer,
   a cellulose-based second layer in contact with said first layer, and
   a cellulose-based third layer in contact with said first layer,
   wherein said first layer is formed of a first pulp mixture comprising a concentration of an internal sizing agent, and
b) subjecting said second and third layer of the formed multilayered cellulose-based substrate to grafting with a fatty acid halide through the entire thickness of said second and third layer, respectively.

According to one aspect, said second layer is formed of a second pulp mixture comprising no internal sizing agent or a lower concentration of internal sizing agent than the first pulp mixture, and said third layer is formed of a third pulp mixture comprising no internal sizing agent or a lower concentration of internal sizing agent than the first pulp mixture.

The cellulose-based third layer is preferably in contact with the first layer such that the first layer is sandwiched between the second layer and the third layer.

The cellulose-based third layer should preferably be capable of being grafted with fatty acids through the entire thickness of the third layer. Thus, in some embodiments the third layer has a basis weight below 150 g/m², preferably below 100 g/m² or below 50 g/m². The third layer preferably has a basis weight above 20 g/m².

In some embodiments, the third layer has a thickness below 200 µm, preferably below 150 µm or below 100 µm . The third layer preferably has a thickness above 30 µm.

In some embodiments, the third layer comprises no internal sizing agent or a lower amount of internal sizing agent than said first layer.

In some embodiments, the multilayered cellulose-based substrate further comprises a coating layer in contact with said first layer. Thus, in some embodiments, the method comprises:
a) forming a multilayered cellulose-based substrate comprising
   a cellulose-based first layer,
   a cellulose-based second layer in contact with said first layer, and
   a coating layer in contact with said first layer,
   wherein said first layer is formed of a first pulp mixture comprising a concentration of an internal sizing agent, and
b) subjecting said second layer of the formed multilayered cellulose-based substrate to grafting with a fatty acid halide through the entire thickness of said second layer.

In some embodiments said second layer is formed of a second pulp mixture comprising no internal sizing agent or a lower concentration of internal sizing agent than the first pulp mixture.

In some embodiments, the coating layer is a mineral coating layer. The mineral coating layer may comprise pigments, binders, and additives. The mineral coating may be further defined as set out above with reference to the first aspect.

In some embodiments the coating layer is a polyvinyl alcohol (PVOH) coating layer. The PVOH coating layer may optionally be subjected to grafting with a fatty acid halide. Grafting of PVOH with a fatty acid halide is described for example in the international patent application WO2009083525A1.

In some embodiments, the coating layer has a basis weight in the range of 1-50 g/m², or more preferably 4-30 g/m².

The forming step a) preferably further comprises drying of the formed multilayered cellulose-based substrate. The formed multilayered cellulose-based substrate is preferably dried to a dry content above 80 %, preferably above 85 %, and more preferably above 90 % by weight.

In some embodiments, the grafting in step b) of the method involves contacting the layer to be subjected to grafting with a fatty acid halide in a liquid, spray and/or vapor state. The cellulose-based substrate is preferably dry when the fatty acid halide grafting is performed. The term “dry” as used herein means that the cellulose-based substrate has a dry content above 80 %, preferably above85 %, and more preferably above 90 % by weight.

The fatty acid halide grafting preferably results in a cellulose-based substrate having a Cobb₆₀ value below 30 g/m². In some embodiments, the cellulose-based substrate subjected to grafting with a fatty acid halide has a Cobb₆₀ value below 20 g/m², preferably below 15 g/m².

The multilayered cellulose-based substrate may further comprise at least one protective polymer layer disposed on a surface thereof. The protective polymer layer preferably comprises a thermoplastic polymer. The polymer layer may for example comprise any of the polymers commonly used in paper-based or paperboard-based packaging materials in general. Examples include polyethylene (PE), polyethylene terephthalate (PET), polypropylene (PP), polylactic acid (PLA) and polyvinyl alcohol (PVOH). Polyethylenes, especially low-density polyethylene (LDPE) and high-density polyethylene (HDPE), are the most common and versatile polymers used.

Thermoplastic polymers, and particularly polyolefins are useful since they can be conveniently processed by extrusion coating techniques to form very thin and homogenous films with good barrier properties. In preferred embodiments, the polymer layer comprises a polyethylene, more preferably LDPE or HDPE.

The protective polymer layer is preferably made of a polymer obtained from renewable resources.

The basis weight of the protective polymer layer is preferably less than 50 g/m². In order to achieve a continuous and substantially defect free film, a basis weight of the polymer layer of at least 4 g/m², preferably at least 8 g/m², is typically required, depending on the polymer used. In some embodiments, the basis weight of the polymer layer is in the range of 4-15 g/m² or in the range of 15-30 g/m².

According to a third aspect illustrated herein, there is provided a carton blank comprising a multilayered cellulose-based substrate according to the first aspect.

According to a fourth aspect illustrated herein, there is provided a container, comprising a multilayered cellulose-based substrate according to the first aspect.

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### Example 1

A bleached board with a grammage of 240 g/m² was mineral-coated on one side with a typical blend of calcium carbonate, styrene/butadien (SB) latex, and thickener. The opposite side of the board was grafted with palmitoyl chloride at 190° C. The Cobb₆₀ value of the grafted surface was 18 g/m². The LA edge-wick resistance (Lactic acid 1 % solution, 1 h at 23° C. and 50 % relative humidity) on the other hand, was very poor with a value of 8.5 kg/m²h. These results show that for mineral-coated substrates with a higher grammage, the grafting alone cannot provide for a sufficient resistance towards penetration of liquids via raw edges.

### Example 2

An unbleached board with a grammage of 350 g/m² and a thickness of 640 µm was not possible to graft efficiently to achieve enough edge penetration resistance. The board was therefore submitted to internal sizing of the middle layer and grafting of the outer unsized layers.

The LA edge-wick resistance (Lactic acid 1% solution, 1 h at 23° C. and 50 % relative humidity) of the reference board with only internal sizing of the middle layer was 1.7 kg/m²h. After grafting the outside layers, the edge penetration decreased to 0.3 kg/m²h. These results show that it is possible to achieve a sufficient resistance towards edge penetration of thick board substrates when combining internal sizing with grafting.

1. A multilayered cellulose-based substrate, comprising:
a cellulose-based first layer, and
a cellulose-based second layer in contact with said cellulose-based first layer,
wherein said substrate has a basis weight above 85 g/m²,
wherein said cellulose-based first layer comprises an internal sizing agent, and
wherein said cellulose-based second layer has been subjected to grafting with a fatty acid halide through an entire thickness of said cellulose-based second layer.

2. The multilayered cellulose-based substrate according to claim 1, wherein said cellulose-based second layer comprises no internal sizing agent or a lower amount of internal sizing agent than said cellulose-based first layer.

3. The multilayered cellulose-based substrate according to claim 1, wherein the thickness of said substrate is above 100 µm.

4. The multilayered cellulose-based substrate according to claim 1, wherein said cellulose-based second layer has a basis weight below 150 g/m².

5. The multilayered cellulose-based substrate according to claim 1, wherein said cel ulose-based
second layer has a basis weight below 85 g/m².

6. The multilayered cellulose-based substrate according to claim 1, wherein said cellulose-based second layer has a thickness below 100 µm .

7. The multilayered cellulose-based substrate according to claim 1, wherein said cellulose-based second layer comprises no internal sizing agent.

8. The multilayered cellulose-based substrate according to claim 1, further comprising
a cellulose-based third layer in contact with said cellulose-based first layer,
wherein said substrate has a basis weight above 85 g/m², and
wherein said cellulose-based third layer has been subjected to grafting with a fatty acid halide through the entire thickness of said cellulose-based third layer.

9. The multilayered cellulose-based substrate according to claim 8, wherein said cellulose-based third layer comprises no internal sizing agent or a lower amount of internal sizing agent than said cellulose-based first layer.

10. The multilayered cellulose-based substrate according to claim 8, wherein said cellulose-based third layer has a basis weight below 85 g/m².

11. The multilayered cellulose-based substrate according to claim 8, wherein said cellulose-based third layer has a thickness below 100 µm .

12. The multilayered cellulose-based substrate according to claim 8, wherein said cellulose-based third layer comprises no internal sizing agent.

13. The multilayered cellulose-based substrate according to claim 1, further comprising
a coating layer in contact with said cellulose-based first layer,
wherein said substrate has a basis weight above 85 g/m².

14. The multilayered cellulose-based substrate according to claim 13, wherein the coating layer is a mineral coating layer.

15. The multilayered cellulose-based substrate according to claim 13, wherein the coating layer is a PVOH coating layer.

16. The multilayered cellulose-based substrate according to claim 13, wherein the coating layer has a basis weight in the range of 1-50 g/m².

17. The multilayered cellulose-based substrate according to claim 1, wherein the cellulose-based first layer, or the cellulose-based second layer, or both is comprised of two or more cellulose-based sublayers.

18. The multilayered cellulose-based substrate according to claim 1, wherein said internal sizing agent is a hydrophobic internal sizing agent .

19. The multilayered cellulose-based substrate according to claim 1, wherein said cellulose-based first layer comprises an amount of internal sizing agent in a range of 0.1-5 kg internal sizing agent per ton of dry substrate.

20. The multilayered cellulose-based substrate according to claim 1, wherein said substrate comprises no added wet-strength agent.

21. The multilayered cellulose-based substrate according to claim 1, wherein a surface of said substrate subjected to grafting with a fatty acid halide has a water contact angle above 90° .

22. The multilayered cellulose-based substrate according to claim 1, wherein said surface of said substrate subjected to grafting with a fatty acid halide has a Cobb₆₀ value (as determined according to standard ISO 535:2014 after 60 seconds) below 30 g/m².

23. The multilayered cellulose-based substrate according to claim 1, wherein said substrate has an edge wick index (Lactic acid 1% solution, 1 h at 23° C. and 50 % relative humidity) below 1.5 kg/m²h.

24. (canceled)

25. A method for manufacturing a multilayered cellulose-based substrate, said method comprising:
a) forming a multilayered cellulose-based substrate comprising
a cellulose-based first layer, and
a cellulose-based second layer in contact with said cellulose-based first layer,
wherein said cellulose-based first layer is formed of a first pulp mixture comprising a concentration of an internal sizing agent, and
b) subjecting said cellulose-based second layer of the formed multilayered cellulose-based substrate to grafting with a fatty acid halide through an entire thickness of said cellulose-based second layer.

26. The method according to claim 25, wherein said cellulose-based second layer is formed of a second pulp mixture comprising no internal sizing agent or a lower concentration of internal sizing agent than the first pulp mixture.

27. The method according to claim 25 further comprising:
a) forming the multilayered cellulose-based substrate comprising
the cellulose-based first layer,
the cellulose-based second layer in contact with said cellulose-based first layer, and
a cellulose-based third layer in contact with said cellulose-based first layer,
wherein said cellulose-based second layer is formed of a second pulp mixture comprising no internal sizing agent or a lower concentration of internal sizing agent than the first pulp mixture, and
wherein said cellulose-based third layer is formed of a third pulp mixture comprising no internal sizing agent or a lower concentration of internal sizing agent than the first pulp mixture; and
b) subjecting said cellulose-based second layer and said cellulose-based third layer of the formed multilayered cellulose-based substrate to grafting with a fatty acid halide through an entire thickness of said cellulose-based second layer and said cellulose-based third layer, respectively.

28. The method according to claim 25, further comprising:
a coating layer in contact with said cellulose-based first layer
.

29. A-The method according to claim 28, wherein said cellulose-based second layer is formed of a second pulp mixture comprising no internal sizing agent or a lower concentration of internal sizing agent than the first pulp mixture.

30. The method according to claim 28, wherein the coating layer is a mineral coating layer.

31. A-The method according to claim 28 , wherein the coating layer is a PVOH coating layer.

32. The method according to claim 25, wherein the grafting comprises contacting the cellulose-based second layer with the fatty acid halide in a liquid state, a spray state, a vapor state, or a combination thereof.
